(19) United States
(12) Patent Application Publication
(10) Pub. No.: US 2011/0287396 A1
(43) Pub. Date: Nov. 24, 2011

(54) Systems and methods for providing a behavioral modification program

(76) Inventors: Richard Gengler, Chicago, IL (US); Roger Sweis, Chicago, IL (US); Peter Gengler, Chicago, IL (US); Thomas Mcgeehan, St. Louis, MO (US); David Paunesku, Palo Alto, CA (US)

(21) Appl. No.: 12/800,763

(22) Filed: May 22, 2010

(51) Int. Cl. G09B 19/00

(52) U.S. Cl. 434/236

(57) ABSTRACT

A method for modifying behavior through a behavioral modification program run on a microprocessor-based computer which provides a user access to the program and generates a modification course associated with the user. During the program, the user participates in an educational module and possibly a communication component, and is associated with at least one modification task. The user provides task feedback, and is evaluated by the program based upon user feedback, for which a reward is provided to the user. The system provides a behavioral modification program, and consists of a microprocessor configured to execute program instructions residing in memory. The program prompts the user to begin, generates a modification course, executes an educational module and possibly a communication component, and associates a modification task with the user, for which task feedback is received. The user is then evaluated on their feedback and issued a reward.

### STATEMENT REGARDING FEDERALLY SPONSORED RESEARCH OR DEVELOPMENT

The U.S. Government has a paid-up license in this invention and may have the right in limited circumstances to require the patent owner to license others on reasonable terms as provided for by the terms of Grant No. 0839750 awarded by the National Science Foundation.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention relates to methods and systems for providing behavioral modification, and more particularly to computer-based and online behavioral modification systems and methods which reward the user.

### BACKGROUND OF THE INVENTION

Behavior modification is the use of empirically demonstrated behavior change techniques to improve behavior, such as altering an individual's behavior and reaction to stimuli through positive and negative reinforcement of adaptive behavior and/or the reduction of maladaptive behavior through therapy.

Behavior modification is used to treat a variety of problems in both adults and children. Behavior modification has been successfully used to treat obsessive-compulsive disorder (OCD), attention-deficit/hyperactivity disorder (ADHD), phobias, anxiety and depression, among other things.

Besides the personal benefits gained by an individual making and adhering to positive lifestyle changes through behavioral modification, there are societal and economic benefits. For example, behavioral modification patients frequently require fewer physician visits, go to the hospital less often, and have fewer surgeries, reducing long term medical costs.

While various means exist to modify behavior, there are several barriers to implementing modification programs, and ensuring their long-term effectiveness. For instance, personnel and budgetary shortfalls exist in health care systems which could prevent a deserving patient from participating in behavioral modification. Moreover, participation in an ongoing support program is often effective for patients making lifestyle changes, but may involve costly medical staff and facilities.

There may also be stigmas surrounding the receipt of certain types of behavioral modification, such as mental health treatment. A recent Pentagon report estimates that one-third of all soldiers returning from deployment suffer from a mental health disorder. However, lack of adequate resources and fear of stigmatization inherent in seeking face-to-face treatment prevent as much as 77% of military personnel from ever getting the needed treatment.

Moreover, lack of patient adherence to a modification program may prevent long-term success. Factors attributed to this may include the inability to gauge the effectiveness of the modification program/system on the patient and/or adapt to the particular behavioral pattern of a patient over time; little or no on-going support mechanism to ensure program compliance; and, insufficient means for motivating the patient to make recommended changes.

Therefore, the need for innovative systems and methods to address this burgeoning healthcare epidemic is critical to the well being of our society.

Accordingly, it is an object of the present invention to provide resource and cost-effective behavioral modification.

A further object of the present invention is to enable users to seek treatment without having to face the fear of stigmatization.

Another object of the present invention is to provide a behavioral modification program which can gauge its effectiveness on the user.

Yet a further object of the present invention is to provide a behavioral modification program which can adapt to the user over time.

Yet another object of the present invention is to provide behavioral modification with support mechanisms for a patient.

Still another object of the present invention is to provide motivation to a behavioral modification patient.

A further object of the present invention is to provide performance-based compensation to the user of a behavioral modification program.

These and other objects and advantages of the present invention will become apparent from the subsequent detailed description of the preferred embodiment and the appended claims taken in conjunction with the accompanying drawings.

### SUMMARY OF THE INVENTION

The objects set forth above as well as further and other objects are achieved by the present invention. The solutions and advantages of the present invention are realized by the illustrative embodiments of the present invention described herein below.

The present invention includes systems and methods related to providing behavioral modification to individuals. In an illustrative embodiment, a method for modifying the behavior of the user of a behavioral modification program run on a microprocessor-based computer is disclosed. Once a user is provided access to the program, a modification course is generated by the program for the user.

The user is then able to participate in a communication session with a peer, the peer being a patient who has completed a behavioral modification program and now acts in a support capacity to current patients. This communication serves as support and motivation for the user. The user may also participate an educational module consisting of various types of content used to educate them on behavioral modification issues, therapies and materials. Once the user completes the educational module, they participate in another communication session, although this time with a program administrator such as a doctor or clinician. This communication reinforces the lessons taught in the educational module. The user may also select a modification task, which includes scheduling the activity to be performed at a certain time. The task may be selected during the education module but scheduled after the education module is completed. The program would then elicit feedback from the user on the activity once its scheduled time for completion has passed. Based upon the feedback, the program can evaluate whether the user has performed the task, and the effectiveness of the program on the user. The evaluation also determines how the user will be rewarded for their participation.

In another illustrative embodiment, a computer-based system is provided for modifying the behavior of a user. The system includes memory containing the behavioral modification program instructions which is coupled to a microprocessor configured to execute the instructions. The system prompts the user to begin the program after which time a modification course is generated. The communication component and educational module are then executed. A modification task is associated with the user, for which feedback is received. The program then evaluates the user feedback and rewards the user.

The system may further include a communications interface coupled to the processor, and a client device having a communications interface, both of which are configured to interface with a network. This allows the client device to access the behavioral modification program over the internet through a web-enabled browser.

In the illustrative embodiments, the behavioral modification program would be artificially intelligent and able to learn information from users of the program. This would allow the program to operate more efficiently over time by providing capabilities to effectively tailor modification courses and better evaluate and reward the user's activities.

### BRIEF DESCRIPTION OF THE DRAWINGS

A more complete understanding of the present invention and the advantages thereof may be acquired by referring to the following description in consideration of the accompanying drawings, in which like reference numbers indicate like features, and wherein:

FIG. 1 is a flow diagram illustrative of a method for modifying the behavior of the user of a behavioral modification program run on a microprocessor-based computer according to an embodiment of the invention;

FIG. 2 is a graphical representation of the notification services provided to the user according to an embodiment of the invention;

FIG. 3 is a flow diagram illustrative of a method for rewarding a user for completing at least one modification task in a behavioral modification program run on a microprocessor-based computer according to an embodiment of the invention; and

FIG. 4 is a block diagram of a system for providing behavioral modification of a user according to an embodiment of the invention.

### DETAILED DESCRIPTION OF THE PREFERRED EMBODIMENT

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope of the present invention.

In a preferred embodiment of the invention, a method is provided for modifying the behavior of the user of a computer-based behavioral modification program. A computer may include any device having software processing capabilities provided by, but not limited to, a microprocessor, commonly referred to as a processor, Intel® Pentium® processor, central processing unit (CPU), graphical processing unit (GPU), or other such processing devices known to one skilled in the art. Multiple computing devices or pieces of hardware may be connected or otherwise in communication locally and/or in a distributed platform, which may individually or collectively be considered as one or more microprocessors or processing units.

It is also preferred that the behavioral modification program be distributed through an online platform, whereby a host or server computer contains and/or executes the behavioral modification program and serves it to users, most preferably as a web-based program accessed through use of a web browser. However, it is also contemplated that the behavioral modification program could be run on various computer systems and networks, such as a single local computer; through machines connected on a local intranet which would not require the use of the internet; through cloud computing; or any other configuration allowing a user to access the program, as would be recognized by those skilled in the art.

With respect to this and other embodiments of the systems and methods herein disclosed, a behavioral modification program user may include, but is not limited to, patients, system administrators, and program administrators. Patients may be considered those users which desire to have their behavior modified by the behavioral modification program. System administrators may include users which provide technical support relating to the system. Program administrators may be users who provide medical or non-technical advice and assistance to a patient, such as doctors, peers and clinicians. Generally, the term “user” as referenced herein refers to a patient. However, the user and aforementioned types of users are merely provided for exemplary purposes, and are not wholly indicative of the various users who may participate in the disclosed methods and systems.

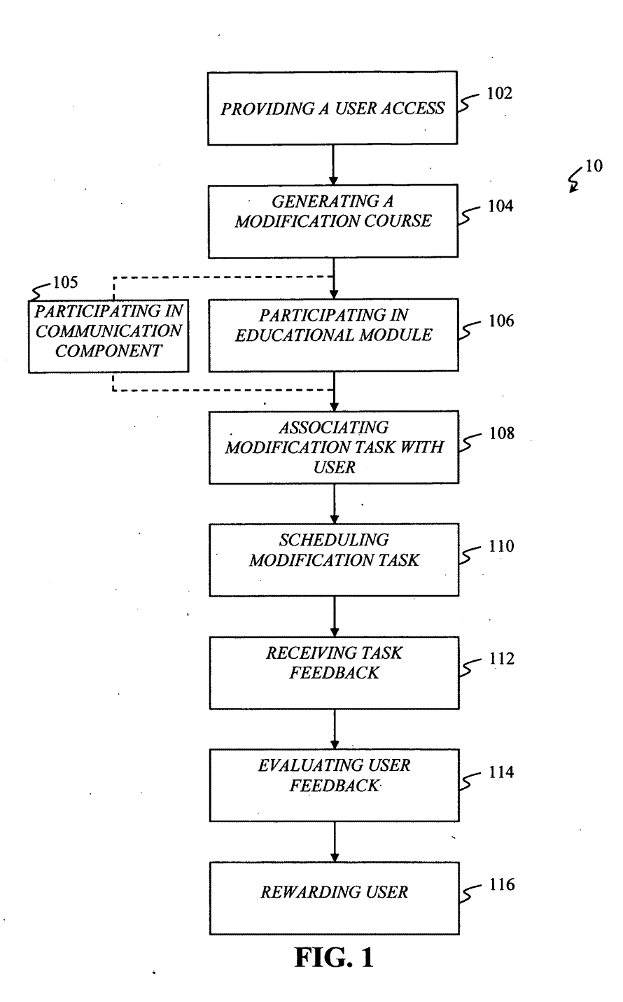

According to the method 10 referred to in FIG. 1, a user is provided access 102 to the behavioral modification program. Providing the user access 102 may include starting the program; logging into the program where a login is required; accessing the program from a remote location, such as over the internet through a web-browser; creating a user profile for a new user; and/or selecting the profile of an existing user. Additionally, when using a user profile, the user profile may be updated or edited before it is provided 102.

Preferably, a user profile will be used and may include login information, such as a user ID and password, personal information, information pertinent to the type and content of the behavioral modification program, as well as any other information regarding the user. For example, if a user is an army veteran using the program to treat depression, the user profile may include such things as their age, sex, length of war zone deployment, as well as information relating to the severity and extent of the depression.

Initially, the user profile information may be created and input into the behavioral modification program by a system administrator, a program administrator, or by the user themself. The user profile may be created manually or through a scripted or otherwise computer-automated process. Once created, the user profile may be subsequently updated with information such as the user's previous experience and level of completion through the program. Preferably this is accomplished by the behavioral modification program where possible, but may also be accomplished by a user or administrator of the program.

Once access 102 to the program is provided, the behavioral modification program generates a modification course 104 to associate with the user. Where a user profile is employed, as in a preferred embodiment, the behavioral modification program may process and transform the profile to generate the modification course 104. The generation 104 may be as simple as having the software associate a predefined modification course with a specific user based on information such as the behavior they wish to modify. The generation 104 may also be more complex, such as having the behavioral modification program individually tailor, and continuously update a unique modification course. This may be based upon information learned about the current user by the behavioral modification program through artificial intelligence, as well as information learned from previous users of the program. Algorithms may be employed by the behavioral modification program to allow it to provide such artificial intelligence or computer-based learning.

The method may further provide that once a modification course is generated 104 by the behavioral modification program, the user is provided the opportunity to participate 106 in an educational module. Educational modules may be scheduled by the user to be completed at certain times. Preferably, the educational module is instructive of some knowledge to be imparted to the user which allows them to recognize the behavior which is to be modified and/or implement changes in such behavior. A module may consist of several mini-modules or lessons, which the user may participate in or complete at one time, or in multiple sessions. Moreover, a behavioral modification program may consist of several educational modules.

The educational module may include any number of audio-visual formats or media which are able to be seen and/or heard on a computer, especially those viewable through a web-browser, such as text, pictures, sound, and/or video. The educational module may be passive in that information is imparted to the user and progression through the module occurs without any input from the user. The educational module may also be interactive in that progression through the educational module requires feedback from the user, referred to herein as module feedback. For example, module feedback may be asking the user to input a response to questions posed in the educational module.

As shown in FIG. 1, the user may participate in a communication component 105 during the behavioral modification program. The communication component allows for discussion or communication, preferably in real-time, between a user of the behavioral modification program and a third party or parties, such as other users, or system and program administrators. The communication may be conducted electronically, such as through instant messaging or video conferencing, or may be conducted via telephone or in person. The communication may be useful in providing the user encouragement and support. The behavioral modification program may intelligently select which third parties are matched with the user during the communications component, when none is already assigned. However, it is also contemplated that the user may select the party or parties involved in the communication. Additionally, a third party may initiate a communication with the user.

It is preferred that the user participate in the communication component 105 directly before and after participating in the educational module 106. The pre-module communication could have the desired effect of motivating the user to complete the program or module, and thus may be initiated between a user and a peer, as is disclosed in the Applicant's copending patent application Ser. No. 12/471,239 filed on May 22, 2009, entitled “SYSTEMS AND METHODS TO INDOCTRINATE AND REWARD A PEER OF A BEHAVIORAL MODIFICATION PROGRAM,” which is fully incorporated herein by reference. Additionally, the post-module communication could have the desired effect of reinforcing the lessons provided in the educational module, and thus be initiated between a user and a clinician. However, in certain embodiments, the communication component may allow contact between a user and third party at any time during the behavioral modification program.

Certain embodiments further provide that at least one modification task be associated 108 with the user within the behavioral modification program. A modification task may be something which reinforces the lessons or behaviors taught in the educational module. For example, a modification program treating depression may suggest the user take part in a modification task encouraging socialization, such as participating in a community event. In a preferred embodiment, the modification task is selected by the user, although a task may be assigned by the behavioral modification program, or a system or program administrator. It is also preferred that the modification task is selected for association with the user during the educational module, but the task may be associated at a time therebefore or thereafter.

Specific types or groups of modification tasks may be made available for selection by the user. However, the behavioral modification program may also allow the user to create their own tasks for completion, rather than select one from a predefined list of tasks.

At some point concurrent or subsequent to the association of the modification task 108, the task may be scheduled 110 for execution by the behavioral modification program. In a preferred embodiment, the modification task is selected by the user during the educational module, but scheduled 110 after the module is completed. It is also preferred that the scheduled time for task execution be selected by the user. However, the task may be scheduled 110 by a program or system administrator, or the behavioral modification program may intelligently schedule 110 an appropriate time for the modification task based upon information learned about the user through artificial intelligence and machine learning algorithms.

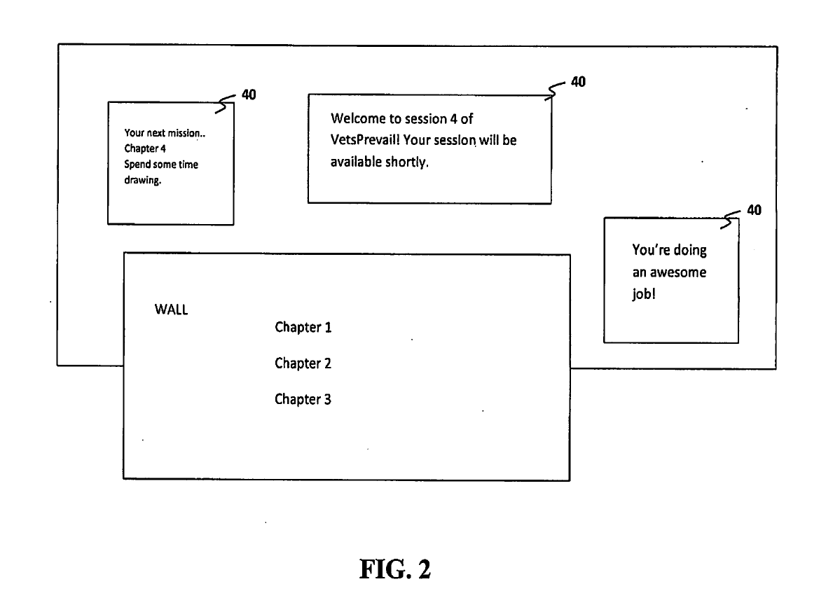

In a preferred embodiment, the method may include the step of providing at least one notification to the user. The behavioral modification program may have the ability to visually display content to the user, such as encouraging messages, number of points accrued, next educational module to be completed, reminders of upcoming scheduled tasks, or any other notification which would be pertinent to the user. As seen in FIG. 2, this may be done, for example, by having various notices 20 displayed to the user once they have accessed the program. Additionally, the notifications may be sent electronically via email, cellular text or multimedia message, and the like. Notifications may also be provided to the user by a third party, such as a program administrator, through personal interactions such as a telephone call inquiring why the user missed their scheduled educational module. The notifications may be generated automatically by the behavioral modification program, or may be initiated by a user, system administrator, or program administrator.

Once the scheduled time for executing a modification task has passed, the behavioral modification program may request that user provide feedback 112 regarding the task, referred to as task feedback. This may occur, preferably, the next time the user accesses the behavioral modification program after the task should have been completed. Exemplary questions that could be asked may relate to the level of pleasure and accomplishment felt by the user after having completed a modification task. Preferably, the task feedback will be used to determine the effectiveness of the program on the user.

In a preferred embodiment, user feedback obtained throughout the behavioral modification program may be evaluated 114 by the behavioral modification program. User feedback may include task and module feedback, as well as other things the user has done or failed to do within or with respect to the behavioral modification program, such as the number of messages sent, and number of educational modules not completed on time. The evaluation 114 may be an ongoing, background process which is executed by the behavioral modification program and goes unnoticed by the user, or it may be performed at certain times throughout the behavioral modification program. Such an evaluation 114 may allow the behavioral modification program to determine the program's effectiveness on the user. Additionally, compliance with the program may also be evaluated based upon whether a user submits that a modification task has been completed.

In a present embodiment, proprietary algorithms are employed to make said evaluation 114, and operate according to many factors culled from the quality and quantity of the user feedback. The user feedback received by the behavioral modification program may increase the program's level of artificial intelligence since more information about a specific user's performance during the program will be received, and correlated with information obtained from other users of the behavioral modification program.

Once the user feedback has been evaluated 114, the user may be provided a reward 116 in some manner by the behavioral modification program, although it may also be provided by a third party. The reward may be based upon the user's participation, experience, and feedback within the behavioral modification program as determined in the evaluation process.

As studies show that behavioral modification is most effective when the modification techniques are encouraged and positively reinforced, the reward may act as an incentive for effective participation in the program. In a preferred embodiment, the reward provided 116 is some form of compensation, such as gift certificates, discounts on products and the like. The reward may also be currency, which would provide the user with a means of income. Moreover, a user may be given free, additional, or reduced price access to the behavioral modification program where access is limited or on a paid basis.

If the user has previously participated in the behavioral modification program, the reward may also or alternatively be an ongoing total, average, or other metric of points or rewards received throughout the program. Thus, the reward may be positively or negatively affected each time the user participates in the behavioral modification program.

With respect to the behavioral modification program disclosed herein, it may be desired that the methods be practiced more than one time. For instance, the behavioral modification may be most effective when the program is repeated several times, or the content of the program may be such that certain behavior is slowly modified over a time, and each time the program is practiced a different lesson is taught or behavior modified. As an example, a behavioral modification program to treat post-traumatic stress disorder (PTSD) may provide that each step of the previous method be practiced, and then repeated each week for a total of six weeks. During each week, the educational module(s) presented may address different topics. One week may address recognizing and stopping negative behavior, whereas the next week addresses learning and practicing positive behavior. As such, to effectively modify the behavior of the user, the behavioral modification program would need to be practiced several times.

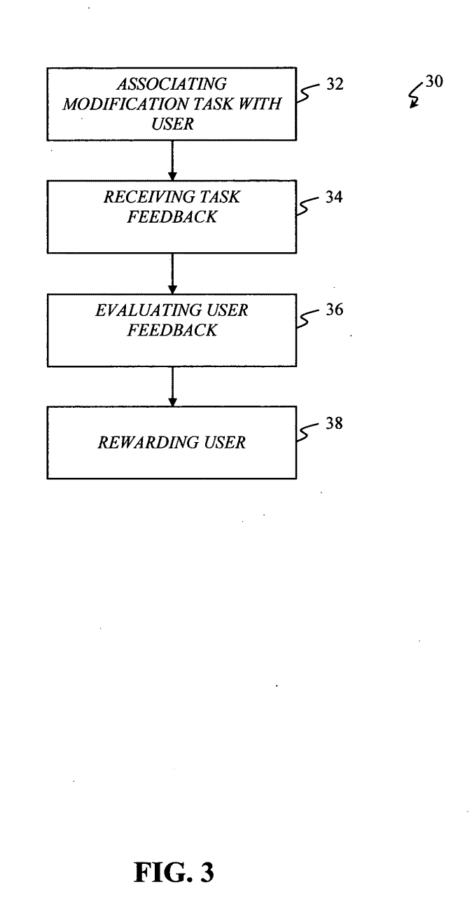

In another embodiment of the invention shown in FIG. 3, a method 30 is provided for rewarding a user for completing at least one modification task in a behavioral modification program run on a microprocessor-based computer. The method 30 comprises: associating the at least one modification task with the user within the behavioral modification program 32; providing task feedback from the user via the behavioral modification program 34; evaluating task feedback by the behavioral modification program 36; and rewarding the user 38. In this method 30, and in accord with previous methods, the feedback provided by the user regarding their completion of the task is evaluated by the behavioral modification program. This allows an assessment of the effectiveness of the program, user compliance with the program, and a determination of the reward to be provided to the user.

With respect to the methods disclosed herein, the method steps provided are not required to be practiced in any particular order unless there is some dependence or relationship which would require such a practice.

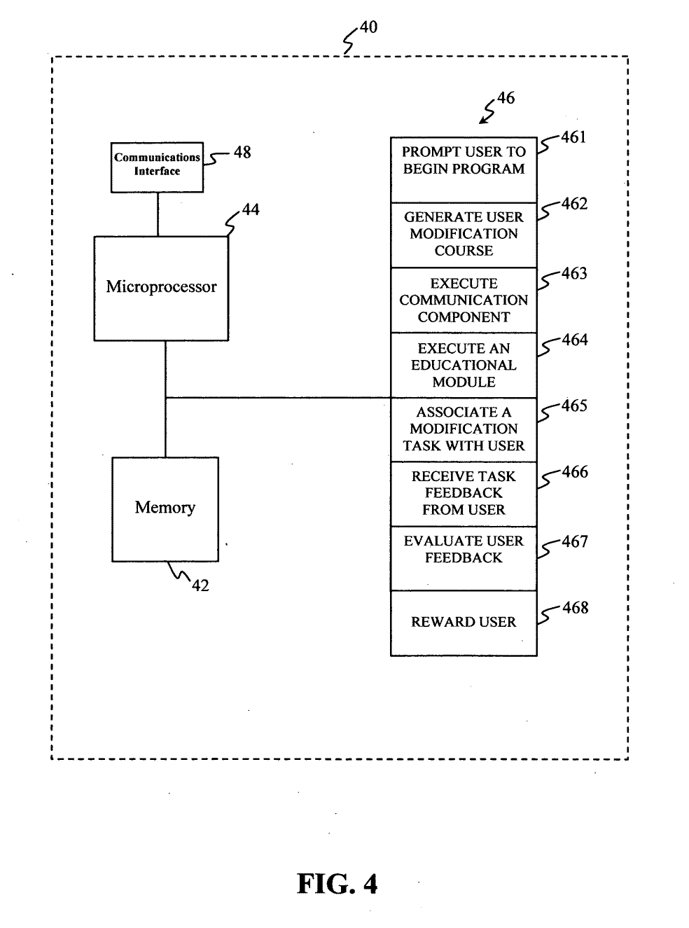

Referring to FIG. 4, a system 40 is disclosed for providing behavioral modification of a user. The system includes at least one memory 42 having behavioral modification program instructions residing thereon. Examples of memory 42, which enable the storage, reading, and/or running of a software program therefrom, include RAM, ROM, hard disks, CDs, DVDs, flash memory, and any other form of local and remote, volatile and non-volatile storage media which may be accessed directly and indirectly by a microprocessor.

The system 40 further includes at least one microprocessor 44 configured to execute the behavioral modification program instructions. Such execution may be carried out by direct or indirect access and reading of the software instructions on the at least one memory 42 by the at least one microprocessor 44, or may involve other, additional hardware and software to carry out same.

The program instructions allow the system 40 to perform several operations 46, which may include at least one of the following: prompting the user to begin the program 461; generating a modification course associated with the user 462; executing a communication component in which the user is participating 463; executing an educational module which the user is experiencing 464; associating at least one modification task with the user 465; receiving task feedback from the user 466; evaluating user feedback 467; and rewarding the user 468.

Prompting the user to begin the program 461 may include starting the program, accessing the program remotely, logging onto the program where a login is required, creating a user profile for a new user, or selecting the profile of an existing user. Additionally, when using a user profile, the user profile may be updated or edited before it is provided.

Preferably, as in the methods, the generation of the modification course 462 is carried out by the behavioral modification program once the user has begun the program. Subsequently, the user progresses through the program, participating in at least one communication component and educational module, on which their performance and feedback is evaluated and rewarded. While it is preferred that a user complete the behavioral modification program in one session, it is provided that the user may participate in the program in multiple sessions.

Additionally, a preferred embodiment of the system 40 further includes a communications interface 48 coupled to the processor 44 and configured to interface with a network, and/or a client device (not shown) having a communications interface configured to interface with a network. This system configuration would allow a client device to access, run, or otherwise experience the behavioral modification program over a network.

The user device may be a computer, personal digital assistant (PDA), cellular phone, video game console, web-enabled television, or any device having network connectivity capabilities. In this embodiment, the term network is used generally to mean any environment which allows the program to be remotely accessed by the user, such as through wired/wireless ethernet, the interne, LAN, WAN, VPN and the like, as would be known to one having skill in the art. The communications interface and network may implemented in a number of various way, including but not limited to, wireless and wired interfaces, RS-232, wired and wireless ethernet, telephone modem, cable modem, universal serial bus (USB), firewire, radio, infrared, bluetooth, HSPA, cellular, satellite, GSM, LAN, WAN, EVDO, and any other types of communications interface and networks as would be known to those skilled in the art.

The present invention includes any novel feature or combination of features disclosed herein either explicitly or any generalization thereof. While the invention has been described with respect to specific examples including presently preferred modes of carrying out the invention, those skilled in the art will appreciate that there are numerous variations and permutations of the above described systems and techniques. Thus, the spirit and scope of the invention should be construed broadly as set forth in the appended claims.

What is claimed is:

1. A method for modifying a behavior of a user of a behavioral modification program run on a microprocessor-based computer, the method comprising:
providing the user access to the behavioral modification program;
generating a modification course associated with the user by the behavioral modification program;
participating in an educational module of the modification program;
associating at least one modification task with the user within the behavioral modification program;
providing task feedback via the behavioral modification program;
evaluating user feedback by the behavioral modification program; and
rewarding the user.

2. The method according to claim 1 wherein providing the user access includes at least one task selected from the group consisting of logging into the program, beginning the program, creating a user profile and selecting a user profile.

3. The method according to claim 1 wherein the Modification course is customized for the user.

4. The method according to claim 1 wherein the educational module participation includes eliciting module feedback from the user.

5. The method according to claim 1 wherein the associating of the at least one modification task includes scheduling of the at least one modification task by the behavioral modification program.

6. The method according to claim 1 wherein the evaluation includes accessing the effectiveness of the program.

7. The method according to claim 1 wherein the reward is based upon the evaluation.

8. The method according to claim 1 wherein the reward includes at least one item selected from the group consisting of monetary compensation, non-monetary compensation, discount goods, discount services, and further user participation in the behavioral modification program.

9. The method according to claim 1 wherein providing access includes accessing the program remotely.

10. The method according to claim 1 further comprising providing at least one notification to the user.

11. The method according to claim 10 wherein the at least one notification is selected from the group consisting of an encouraging message, number of points accrued by the user, next educational module to be completed, and reminders of upcoming scheduled tasks.

12. The method according to claim 1 further comprising participating in a communication component of the behavioral modification program.

13. A method rewarding a user for completing at least one modification task in a behavioral modification program run on a microprocessor-based computer, the method comprising:
associating the at least one modification task with the user within the behavioral modification program;
providing task feedback via the behavioral modification program;
evaluating task feedback by the behavioral modification program; and
rewarding the user.

14. The method according to claim 13 wherein the task feedback requests the level of pleasure and accomplishment felt by the user.

15. A system for providing behavioral modification of a user comprising:
at least one memory having behavioral modification program instructions residing thereon; and
at least one microprocessor configured to execute the behavioral modification program instructions to perform the operations of: prompting the user to begin the program;
generating a modification course associated with the user;
executing an educational module which the user is experiencing;
associating at least one modification task with the user,
receiving task feedback from the user;
evaluating user feedback; and
rewarding the user.

16. The system according to claim 15 wherein prompting the user to begin the program is accomplished by performing at least one task selected from the group consisting of logging into the program, beginning the program, creating a user profile and selecting a user profile.

17. The system according to claim 15 further comprise executing a communication component in which the user is participating.

18. The system according to claim 15 wherein the communication component is executed during at least one time frame selected from the group consisting of before the educational module and after the educational module.

19. The system according to claim 15 further comprising:
a communications interface coupled to the processor and configured to interface with a network; and
a client device having a communications interface configured to interface with a network, wherein the client device is able to access the behavioral modification program over the network.

20. The system according to claim 19 wherein the client device access to the system is provided through a web browser over the interne.
